(19) United States
(12) Patent Application Publication
(10) Pub. No.: US 2010/0227185 A1
(43) Pub. Date: Sep. 9, 2010

(54) T-Molding

(76) Inventor: Harry V. Empting, JR., Lake City, TN (US)

Correspondence Address: PITTS AND BRITTIAN P C, P O BOX 51295, KNOXVILLE, TN, 37950-1295, US

(21) Appl. No.: 12/399,229

(22) Filed: Mar. 6, 2009

(51) Int. Cl. B32B 25/08; B29C 47/04

(52) U.S. Cl. 428/495; 156/244.17

(57) ABSTRACT

The T-Molding comprises a flame treated under layer comprising a blend of a polyolefin with an antioxidant; and an outer layer secured to said under layer and comprising an acrylic.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to flexible T-Molding

More particularly, this invention pertains to an improved T-Molding edge comprising an extrusion of a rubber modified polypropylene blended with an antioxidant and coated with an ultraviolet light cured acrylic.

2. Description of the Related Art

T Molding is used as a protective and decorative covering for the edge of composite board or plywood, which has a decorative top surface, such as Formica, for example. This type of construction is very often used in the production of office furniture. The T-Molding is secured to the board by slotting the edge of the board then hammering or pushing the barb of the T-Molding into the slot.

In the past, T-Molding has commonly been formed from flexible PVC. PVC has good abrasion resistance and trims easily. More importantly, PVC is dangerous to the environment because, if burned, it decomposes to release chlorine gas, a dangerous chemical.

Polypropylene is a thermoplastic random copolymer which is generally environmentally “friendly.”

### BRIEF SUMMARY OF THE INVENTION

According to one embodiment of the present invention, T-Molding comprises an extrusion of a rubber modified polypropylene blended with an antioxidant and coated with an ultraviolet light cured acrylic.

### DETAILED DESCRIPTION OF THE INVENTION

T-Molding comprises a flame treated under layer comprising a blend of a polyolefin with an antioxidant and an outer layer secured to said under layer and comprising an acrylic is disclosed.

In one embodiment, the antioxidant is selected from products sold under the trade name of Ciba 225 and Ciba FS301. CIBA 225 allows color pinking, therefore it is replaced with CIBA FS 301. The antioxidant is blended with a polyolefin, preferably a rubber modified polypropylene, such as Santo Prene-Sarlink available from DSM Elastomers.

The under layer is flame treated at a temperature of about 176° to about 192° degrees centigrade, preferably from about 180° to 190° degrees centigrade.

An outer layer comprising an acrylic, preferably an ultraviolet light cured acrylic, is applied onto the flame-treated under layer.

As discussed hereinabove, the exposed outer layer provides improved abrasion resistance.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. T-Molding comprising:
a flame treated under layer comprising a blend of a polyolefin with an antioxidant; and
an outer layer secured to said under layer and comprising an acrylic.

2. The T-Molding of claim 1 wherein said under layer comprises rubber modified polypropylene.

3. The T-Molding of claim 1 wherein said outer layer comprises an ultra violet cured acrylic.

4. The method of manufacturing a T-Molding comprising the steps of extruding an under layer comprising a blend of a polyolefin with antioxidant;
treating said under layer with a flame; and
adhering an upper layer comprising an acrylic to said under layer.

5. The method of claim 4 wherein said under layer comprises rubber modified polypropylene.

6. The method of claim 4 wherein said outer layer comprises an ultra violet cured acrylic.
